(19) United States
(12) Patent Application Publication
(10) Pub. No.: US 2009/0167026 A1
(43) Pub. Date: Jul. 2, 2009

(54) Inlet passageway and sealing in a turbine wind power generating system

(76) Inventor: Russel Hugh Marvin, Goshen, CT (US)

Correspondence Address: Ted Paulding, 10 Penwood Lane, Wethersfield, CT, 06109, US

(21) Appl. No.: 12/006,024

(22) Filed: Dec. 28, 2007

(51) Int. Cl. H02P 9/04

(52) U.S. Cl. 290/55; 415/83

(57) ABSTRACT

IMPROVED INLET PASSAGEWAY AND SEALING IN A TURBINE WIND POWER GENERATING SYSTEM wherein sharp very small radii of curvature end portions at the mouth or inlet to the passageway avoid turbulence thus enhancing inlet airflow. Transitional portions of the passageway are arranged at angles of inclination with the horizontal to provide for smooth airflow to a rear impact and transfer portion of the passageway which takes a concave parti-circular configuration. Turbulence adjacent the end portions and within the inlet passageway is thus avoided. Sealing means between an annular shroud or blade tip ring and an adjacent stationary ring take the form of labyrinth seals minimizing loss of airflow through the blades.

### BACKGROUND OF THE INVENTION

Twin wind turbines mounted on a common rotatable support for rotation about horizontal axes are shown in the following U.S. patents, disclosures incorporated herein by reference:
U.S. Pat. No. 4,021,140
U.S. Pat. No. 4,156,479
U.S. Pat. No. 4,288,199
U.S. Pat. No. 4,332,518
U.S. Pat. No. 4,540,333

Reference is also had to:

U.S. patent application Ser. No. 11/820,741 filed Jun. 19, 2007 entitled IMPROVED CONTROL SYSTEM FOR TWIN TURBINE WIND POWER GENERATING SYSTEM invented by Russel H. Marvin, hereby incorporated herein by reference,

U.S. patent application entitled IMPROVED GENERATOR OUTPUT CIRCUITRY FOR TWIN TURBINE WIND POWER GENERATING SYSTEM, filed Sep. 21, 2007, invented by Russel H. Marvin, hereby incorporated herein by reference, and

U.S. patent application entitled SYSTEM FOR OPERATING A GENERATOR AS A MOTOR IN A TURBINE WIND POWER GENERATING SYSTEM, filed Sep. 21, 2007, invented by Russel H. Marvin, hereby incorporated herein by reference.

Improved control systems for operating the apparatus of the aforesaid patents are disclosed in the aforesaid patent applications. The present application relates to improvements in airflow control and, more particularly, wind inlet passageways for the turbines and sealing of the turbines.

It is the general object of the present invention to provide a twin wind turbine system of the type mentioned with inlet passageways and sealing systems which maximize turbine performance.

### SUMMARY OF THE INVENTION

In fulfillment of the foregoing object and in accordance with the present invention, a concave interior or rear central impact and redirection portion of each inlet passageway is provided with a generally part-circular configuration for efficient wind collection and transfer to its associated turbines. Forwardly facing convex opposite end portions at the mouth of each passageway viewed in cross section have a sharp pointed or very small radius of curvature for entry of the wind and direction of the same rearwardly toward the central portion of the passageway. The radius of curvature of said end portions may fall in the range of 0 to 0.25 the diameter of the turbines, and may be as low as 0.1 and is preferably in the neighborhood of 0.

Transitional portions of each passageway between the end portions and central portion of the passageway which are preferably linear co-operatively converge from the end portions to the parti-circular central portion at a preselected angle of inclination with the horizontal so as to blend smoothly with the central portion. When there are two parallel wind turbines on opposite sides of the accelerator, a common wind passageway extends in a generally diverging arcuate manner from a front portion of the accelerator to each of the turbines. More particularly, the wind passageway extends arcuately from the front of the accelerator through approximately one hundred eighty degrees (180°) in each direction toward the wind turbines. The passageway is generally parti-circular viewed vertically in cross section in its presently preferred form and opens radially outwardly substantially throughout its length between the wind turbines for maximum wind collection.

With regard to improved sealing in the wind power generating system, it will be noted that an annular shroud or end ring interconnects the turbine blades at their tip portions and rotates therewith. The ring is preferably integral with the blades. A second annular ring which is stationary surrounds the blade tip ring in close relationship therewith and sealing means are provided for restricting the flow of air between the blade tip ring and the stationary ring and thereby directing maximum airflow through the blades. In preferred form, at least one labyrinth seal is provided in association with the blade tip ring and stationary ring and as shown in the drawings, two labyrinth type seals are provided respectively on opposite ends axially of the passageway between the blade ring and the stationary ring.

Preferably, the individual turbine blades, a supporting hub structure and the annular ring thereabout, are molded integrally in a unitary plastic molding process. Optionally, a reaction injection molding process is employed.

### DESCRIPTION OF THE DRAWINGS

FIG. 1 is a schematic view of a tower carrying a vertical series of supports or accelerators each in turn carrying a pair of wind turbines spaced apart horizontally and each rotatable about a horizontal axis, the axes being in parallel relationship.

FIG. 2 is an enlarged view of a single support or accelerator and a pair of wind turbines mounted thereon.

FIG. 3 is an enlarged horizontal cross sectional view through a support or accelerator showing wind flow therethrough.

FIG. 4(AB) is a block diagram illustrating twin turbines and their associated generators and control means.

FIG. 5 is a cross sectional view of a wind inlet passageway in the PRIOR ART

FIG. 6 is a cross sectional view of the improved wind inlet passageway of the present invention.

FIG. 7 is a somewhat schematic vertical section through a wind turbine showing the relationship of an annular shroud or blade tip ring and an adjacent stationary ring.

FIG. 8 is an enlarged view of a portion of FIG. 7 showing sealing means and the relationship thereto of the annular ring about the blades and the associated stationary ring.

### DESCRIPTION OF PREFERRED EMBODIMENT

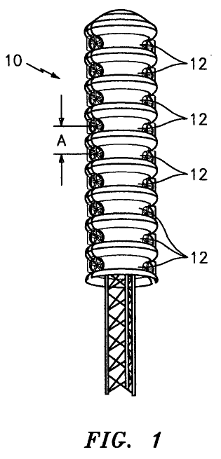

Referring particularly to FIG. 1, a tower indicated generally at 10 carries a vertical stack of ten (10) horizontally rotatable accelerators 12,12.

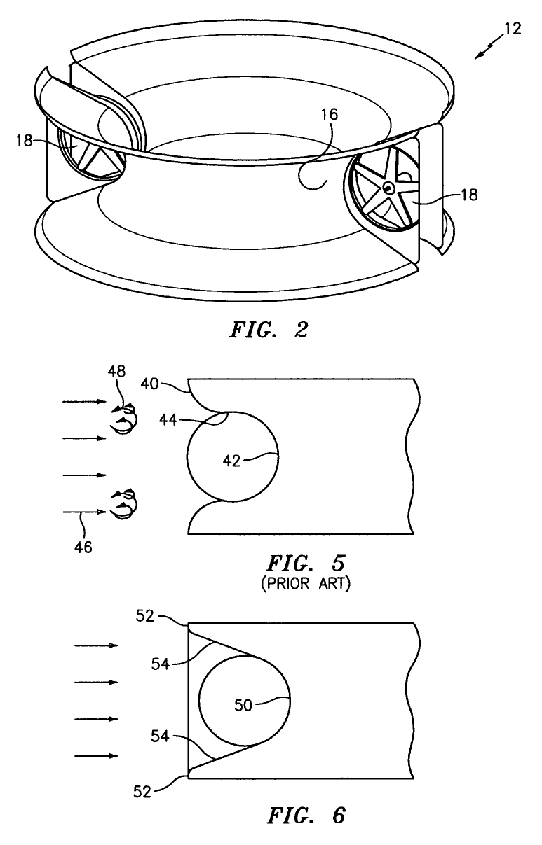

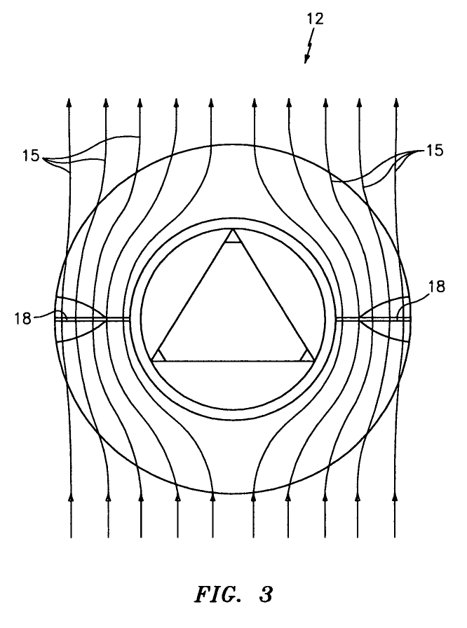

As best illustrated in FIG. 2, each accelerator 12 takes a generally circular configuration with an annular recess 16, approximately semi-circular in cross section, opening radially outwardly and extending throughout its circumference. Twin turbines 18,18 are mounted on horizontal shafts and spaced apart one hundred and eighty degrees to receive bifurcated wind generated air streams 15,15 as best illustrated in FIG. 3. As will be apparent, each stream of air is accelerated as it proceeds from the front of the accelerator rearwardly and outwardly about the arcuate interior surface of the recess 16.

Spacing of the turbines vertically is also important and it should be noted that the vertical spacing A between turbines should be greater than 1.25 the diameter of the turbines.

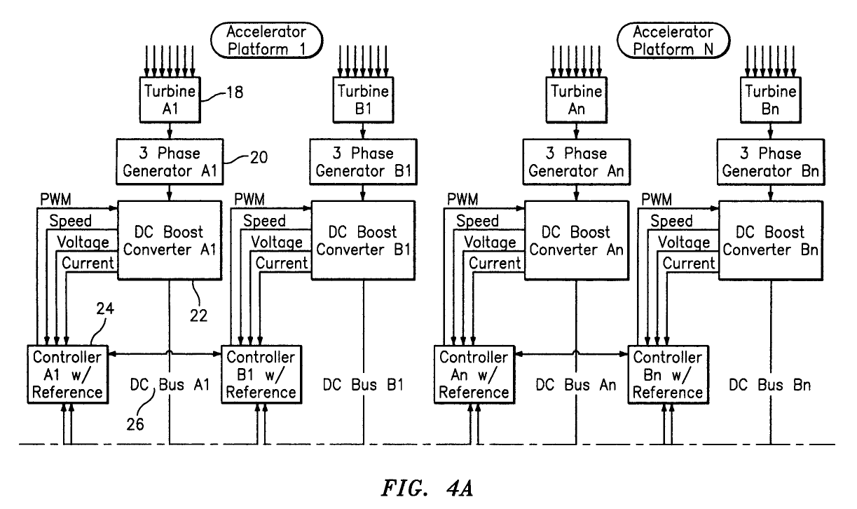

Referring now to FIGS. 4A and B, it will be obvious that all four turbine generator control systems shown are identical with A1 and B1 representing turbines in common on a first accelerator and An and Bn representing turbines mounted in common on other accelerators. The A1 system will be described as representative.

Turbine 18 drives generator 20 which may be conventional and of a variety of different constructions but which is preferably of the three-phase permanent magnet AC type. Boost converter 22 may be conventional with variable pulse width capability and has conventional speed, voltage and current sensing means associated therewith and connected with controller 24. Controller 24, preferably a conventional micro processor, receives signals from the sensing means, calculates power therefrom, and compares with a reference in the form of a desired performance curve. The computer 24 then adjusts the PWM duty cycle to adjust generator output as required to bring the output into compliance with the desired curve. Further, the computer serves to adjust the generator output to adjust the thrust of its associated turbine and thereby adjust the angular position of the accelerator to maintain an optimum angle of attack for the wind relative to the turbine blades. This is accomplished by adjusting the relative thrust until the accelerator stops rotating.

From the boost converter 22 generator output proceeds conventionally through DC bus 26, inverter 28, and disconnect switch 30 to grid 32.

Referring now to the PRIOR ART shown in FIG. 5 it will be observed that a blunt nosed cross sectional configuration is provided at end portions of the wind inlet passageway having relatively large radii at 40,40. An interior concave portion of the passageway 42 is parti-circular and transitional portions of the passageway at 44,44 extend from the entry rearwardly to the portion 42 at substantially zero degrees with the horizontal. With this configuration and with wind flowing in the direction of the arrows 46, 46, severe turbulence occurs adjacent the blunt nose sections 40,40 and there may also be significant turbulence in the interior of the passageway due to the relatively sharp turn at the rear end of the substantially horizontal sidewall, that is, the absence of a smoothly blending juncture with the concave rear portion.

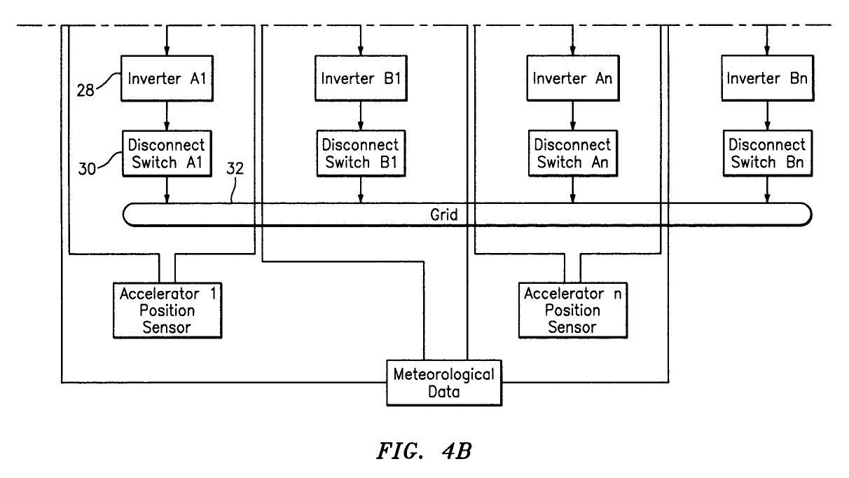

Referring now to FIG. 6, an improved passageway of the present invention has a substantially parti-circular concave central portion at 50 with the passageway viewed in cross section. Opposite end portions 52, 52 are quite sharp and almost pointed with minimal radii of curvature. For example, radii of curvature in the range 0 to 0.25 turbine diameter may be employed with the presently preferred radii of curvature in the neighborhood of 0. Transitional portions of the passageway at 54, 54 are preferably linear and arranged at significant angles of inclination with the horizontal to provide a smooth flow from the entry or end portions to the concave impact or redirection and transfer portion 50 of the passageway. With this configuration little or no turbulence occurs adjacent the narrow nose portions 52, 52 or in the interior of the passageway and a smooth overall airflow is achieved with enhanced turbine performance.

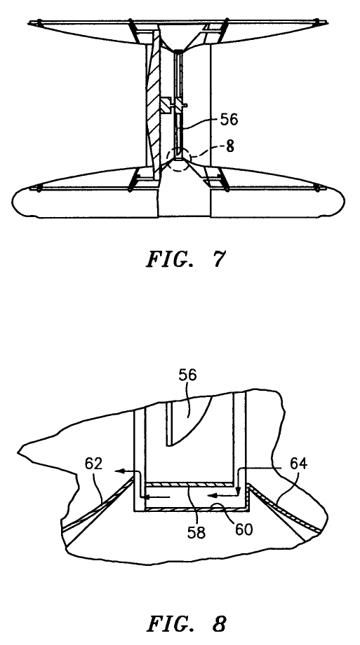

Referring to FIGS. 7 and 8, it will be observed that turbine blades 56, 56 are provided with shroud or tip ring 58 adjacent stationary annular ring 60. As is known, enhanced blade performance is achieved with a minimal loss of airflow radially outwardly about the turbine as might occur between the rings 58 and 60. Accordingly, a sealing means is provided and takes the form of labyrinth seals at 62 and 64. The seals 62,64 minimize the loss of airflow between the rings 58,60 with the air instead passing through the turbine blades as desired.

From the foregoing it will be apparent that enhanced performance of the wind turbines is achieved with the improved inlet passageway of the present invention and particularly when the improved inlet passageway is taken in combination with the improved sealing provided by the labyrinth seals of the invention.

1. In a wind power generating system comprising at least two similar variable speed wind turbines rotatable about substantially parallel horizontal axes and mounted respectively on vertically adjacent horizontally rotatable accelerators, the vertical spacing between turbine axes being greater than 1.25 the diameter of the turbines, at least one electrical generator connected with and driven by said turbines in turn connected with and supplying an electrical load, said accelerators carrying said turbines each defining a passageway designed to capture and direct a stream of wind through an arcuate horizontal path to its associated wind turbine, each said passageway having an interior forwardly facing concave central portion viewed in cross-section which is generally parti-circular for wind impact, redirection horizontally and transfer to the turbine, forwardly facing convex exposed opposite end portions at the mouth of the passageway viewed in cross-section each having a sharp substantially pointed radius of curvature for entry of the wind and direction of the same rearwardly toward the central portion of the passageway, the radii of said end portions falling in the range of zero (0) to 0.25 the diameter of the turbines, and smooth transition portions converging toward the central portion from the front end portions of each passageway.

2. A wind power generating system as set forth in claim 1, wherein the radius of curvature of the end portions of the passageways falls in the neighborhood of zero (0) to 0.1.

3. A wind power generating system as set forth in claim 2 wherein the radius of curvature of the end portions is approximately zero (0).

4. A wind power generating system as set forth in claim 1 wherein said transition portions of said passageway are linear.

5. A wind power generating system as set forth in claim 1, wherein at least two variable speed wind turbines are mounted for rotation about horizontal axes in common on a horizontally rotatable accelerator on opposite sides of the vertical axis of rotation of the accelerator, and wherein a unitary wind passageway extends continuously in opposite directions and in a generally diverging arcuate path from a front portion of the accelerator to each of the turbines.

6. A wind power generating system as set forth in claim 5, wherein each wind passageway extends arcuately from the front of the accelerator through approximately one hundred eighty degrees (180°) in each direction to the wind turbines.

7. A wind power generating system as set forth in claim 5, wherein each of said wind passageways is generally parti-circular viewed vertically and open radially outwardly substantially throughout its length between the wind turbines.

8. A wind power generating system as set forth in claim 1, wherein each turbine has an annular ring interconnecting its blades at their tip portions and rotating therewith, and wherein a second stationary annular ring surrounds the blade tip ring in close relationship therewith.

9. A wind power generating system as set forth in claim 1, wherein sealing means are provided for restricting the flow of air between the blade tip ring and the stationary ring thereabout and thereby directing maximum flow through the blades.

10. A wind power generating system as set forth in claim 1, wherein at least one sealing means associated with the blade ring and stationary ring is a labyrinth seal.

11. A wind power generating system as set forth in claim 10, wherein seals of the labyrinth type are provided on both axial sides of each passageway between the blade ring and the stationary ring.

12. A wind power generating system comprising at least one variable speed wind turbine mounted on a horizontally rotatable accelerator for rotation about a horizontal axis, an electrical generator connected with and driven by said turbine and in turn connected with and supplying an external electrical load, an annular ring interconnecting the turbine blades at their tip portions and rotating therewith and a stationary ring about said annular blade tip ring and in close relationship therewith.

13. A wind power generating system as set forth in claim 12 wherein sealing means are provided for restricting the flow of air between the blade ring and the stationary ring thereabout and thereby directing maximum flow through the blades.

14. A wind power generating system as set forth in claim 13 wherein at least one sealing means requires bypass air to change direction abruptly at least once.

16. A wind power generating system as set forth in claim 13 wherein at least one sealing means associated with the blade ring and stationary ring is a labyrinth seal.

17. A wind power generating system as set forth in claim 16 wherein seals of the labyrinth type are provided on both axial sides of the passageway between the blade ring and the stationary ring.

18. A wind power generating system as set forth in claim 12 wherein the turbine blades, a supporting hub structure, and the annular ring about the blades are integrally molded in a one-piece plastic molded process.

19. A wind power generating system as set forth in claim 18 wherein an injection molding process is employed.

20. A wind power generating system as set forth in claim 12 wherein blade edges are at least partially enclosed through 360 degrees.

21. A wind power generating system as set forth in claim 12 wherein turbine inlets provide a funnel like configuration transitioning air into the turbines.

22. A wind power generating system as set forth in claim 12 wherein each turbine has a funnel like shape at its outlet to diffuse air from the turbine.
